(19) United States
(12) Patent Application Publication
(10) Pub. No.: US 2011/0302504 A1
(43) Pub. Date: Dec. 8, 2011

(54) Mobile Application for Proximity Based Awareness System

(76) Inventors: Santosh Khare, Bellevue, WA (US); Kiran Modak, Bellevue, WA (US); Justin Richardson, Bellevue, WA (US)

(21) Appl. No.: 13/156,119

(22) Filed: Jun. 8, 2011

Related U.S. Application Data
(60) Provisional application No. 61/352,770, filed on Jun. 8, 2010.

(51) Int. Cl. G06F 3/01

(52) U.S. Cl. 715/751

(57) ABSTRACT

A proximity-based awareness system that includes a mobile computing device for each user and a system server in communication with the mobile devices. The system server may enable the user to create and edit a personal profile; broadcast the profile to another user; enable the user to search for and view another's personal profile and an event profile; bookmark an interesting event and an interesting user based on keywords; store a profile image or profile video associated with the user, and designate a virtual presence at a location. Each mobile device includes a processor that may determine the location of the user; provide an interface to enable the user to interact with the system server, transmit information to the system server, and display information received from the system server; and allow the user to enter keywords. As such, the system allows users to become aware of other nearby users.

### CROSS-REFERENCES TO RELATED APPLICATIONS

This patent application claims the benefit of U.S. Provisional Patent. Application Ser. No. 61/352,770 filed Jun. 8, 2010 for THE UNSOCIAL FUNCTIONAL SPECIFICATION. That application is incorporated here by this reference.

### TECHNICAL FIELD

This invention relates to mobile computing applications to facilitate social and business networking.

### BACKGROUND ART

With business becoming increasingly mobile, today's business professional is continuously on the move and one of the essentials tools of business today is the mobile phone. The business professional, via a mobile phone connected to the Internet, is increasingly in touch with physical business entities surrounding them. But when it comes to being aware of the people surrounding the business professional, the mobile phone has no answers.

The disclosed mobile application may solve that problem by allowing a user to become aware of the people in their immediate proximity. Also, through the application the users are able to broadcast their details. The application may compile data of people and their details and present them in format that is easy to browse and get information. This information may have communication details of the various users, and the users may be able to communicate with each other via the application.

One such example of using this application is at a busy airport where various people waiting for their flights would be able to broadcast their details to other users. Alternatively, imagine that you are sitting in a coffee shop waiting for your next meeting and wondering who else is there in the coffee shop that you want to introduce yourself to. The users of the disclosed system can communicate with other users they feel are potential match for their business or personal interests. The users may use the application to become aware of each other and setup a physical meeting within their proximity. The disclosed application enables the users to network within their local area.

The list of users in the application is always changing and can depend upon time and space. The network is transient in nature and the surrounding people are always changing depending upon the time and the area the user is in.

Typically, those looking to gather information about events in their proximity have to go to the web to gather that information. By way of a mobile application, this system enables users 10 become aware of events in their proximity and allows them to filter the events by interest.

### DISCLOSURE OF INVENTION

Accordingly, one aspect of the invention can be described as a proximity-based awareness system for a group of users. The group of users includes an exemplary user (designated as the “illustrative user” in the discussion that follows) and other users. The awareness system includes a mobile computing device for each user in the group of users and a system server.

The system server is remote from but in communication with each of the mobile computing devices, and the system server includes a database. During operation, the system server may perform all or some of the following steps: (a) enabling the illustrative user to create and edit a personal profile of the illustrative user containing information about the illustrative user; (b) enabling the illustrative user to select a privacy setting to limit a shareable level of information about the illustrative user in the illustrative user's personal profile; (c) broadcasting the illustrative user's personal profile to at least one of the other users based on the privacy setting, each of the other users having a respective other user's personal profile; (d) enabling the illustrative user to search for and view at least one other user's personal profile; (e) enabling the illustrative user to search for and view an event profile, the event profile being associated with an event occurring within a proximity boundary, the proximity boundary being a predetermined distance from the mobile computing device of the illustrative user; (f) enabling the illustrative user to disclose to the other users an intention to attend the event, the intention to attend the event being visible to the other users upon viewing the event profile; (g) automatically bookmarking an interesting event based on one or more keywords previously provided by the user; (h) automatically identifying an interesting other user based on the one or more keywords: (i) storing a profile image associated with the illustrative user; (j) storing a profile video associated with the illustrative user; and (k) recording the identifying information for the first geographic location in the database.

Each mobile computing device includes a processor. During operation, the processor may perform all or some of the following steps: (a) determining a first geographic location of the illustrative user by executing an application programming interface (API) to access a geo-locating application; (b) transmitting identifying information for the first geographic location to the system server; (c) providing an interlace to enable the illustrative user to interact with the system server, transmit information to the system server, and display information received from the system server; (d) displaying at least one other user's personal profile; (e) displaying the profile image; (f) displaying the profile video; (g) displaying the event profile; (h) displaying a list of users present and virtually present within the proximity boundary; and (i) allowing the user to enter the one or more keywords.

In addition, the system server may also perform one or both of the following steps: (a) automatically registering the illustrative user based on the first geographic location of the illustrative user, and (b) designating a virtual presence at a second geographic location that is distinct from the first geographic location.

### BRIEF DESCRIPTION OF DRAWINGS

FIG. 1 shows a general overview of an embodiment of a Mobile Application for Proximity Based Awareness System.

FIG. 2 is an example of the display of the home screen in a version of the disclosed system.

FIG. 3 is an example of the display of the sign up screen in a version of the disclosed system.

FIG. 4 is an example of the display of the results screen for a list of users in a version of the disclosed system.

FIG. 5 is an example of the display of the results screen for the details of a particular user in a version of the disclosed system.

FIG. 6 is an example of the display of the results screen for a list of events in a version of the disclosed system.

FIG. 7 is an example of the display of the tag setup screen in a version of the disclosed system.

FIG. 8 is an example of the display of the results screen for a list of auto-tags in a version of the disclosed system.

FIG. 9 shows the conceptual flow for the “live now” feature in a version of the disclosed system.

FIG. 10 is an example of a digital billboard in a version of the disclosed system.

FIG. 11 shows the conceptual flow for the “virtual presence” feature in a version of the disclosed system.

FIG. 12 is a flowchart for finding people around the user in a version of the disclosed system.

FIG. 13 is a chart for the tagging and auto-tagging features in a version of the disclosed system.

FIG. 14 is a flowchart for finding events around the user in a version of the disclosed system.

FIG. 15 is an example of the display of the results screen for the “live now” feature in a version of the disclosed system.

FIG. 16 is an example of the display of the results screen for a list of users in a version of the disclosed system.

FIG. 17 is an example of an event details screen in a version of the disclosed system.

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The disclosed system is a proximity based awareness system that enables individuals (People) and social gatherings (Events) to broadcast themselves. The system gives an opportunity to individuals to initiate contact with other individuals who are otherwise unknown to them. Similarly, the system also enables individuals to become aware of social gatherings that are happening or going to happen in their proximity. The system includes software that automatically registers, or detects, each individual's presence in a geographical location based on their use of the system.

The system also includes a registration system that enables users to create and develop a personal profile to easily broadcast information about themselves. Immediately following a successful creation of a user profile, a user may look up other people as well as other events that are in the user's proximity or area of interest. The system can enable the user to drill down to lookup specifics about other people's personal profiles. The system may include privacy software to enable the system to appropriately display specific personal profile information based on individual's privacy settings (Preferences).

The system can enable the user to see detailed description of events and allows the user to disclose if they intend to attend a specific event. This disclosure of the intent-to-attend becomes known to other users that view the details of this specific event.

The system includes software that automatically bookmarks and actively finds interested people and events for the user. These auto-bookmarking and searching functions can result from keywords, or tags, provided by the user to the system. Also, the system can check the database to provide appropriate search results containing people and events that belong to that keyword or tag.

The system can also include a component to display profile images and videos of individuals as digital billboards. These images and videos can be developed by individuals using this system or else imported from an external source.

The system may enable users to change their location of presence. This feature can enable the user to be “virtually present” in a geolocation without having to physically be present there. This “virtual presence” can be marked by the system to distinguish the profiles of physically present people from those that are virtually present.

The system can also enable users to effectively connect with individuals or attend an event by providing a stepwise workflow that has a list of to-do items that the user may want to do while exploring an individual's profile or attending an event. The system can include software that can present different features that an event may expose. This software can enable (display) or disable (hide) these features based on the context such as time and location.

The application may have a springboard as a start. It may be a 3×3 grid which may have an infinite number of pages where each page has a maximum of 9 items. If the number of items is more than 9, users can move to subsequent pages by using a swipe gesture. In a version of the system, the first page may have following icons: People, Events, Messages, Profile, Tips, Tags, Live Now, Digital Billboard, and Video Ad. The icons that appear may also depend on settings indicated by the user. In addition, there may be other icons, too, such as for events for which the user indicated an intention to attend.

The Tags icon may include a badge displaying how many new items were tagged since the user's last visit. Also, the Live Now icon may include a badge displaying how many event items are currently live. Likewise, the Message icon may also include a badge.

At the top of the home screen, there may be a text box which has a placeholder query “What you are looking for.” This may be updated in the user's profile and each time the user is displayed in the tags of other users.

The screen views on the user's mobile computing device may be as indicated in the figures.

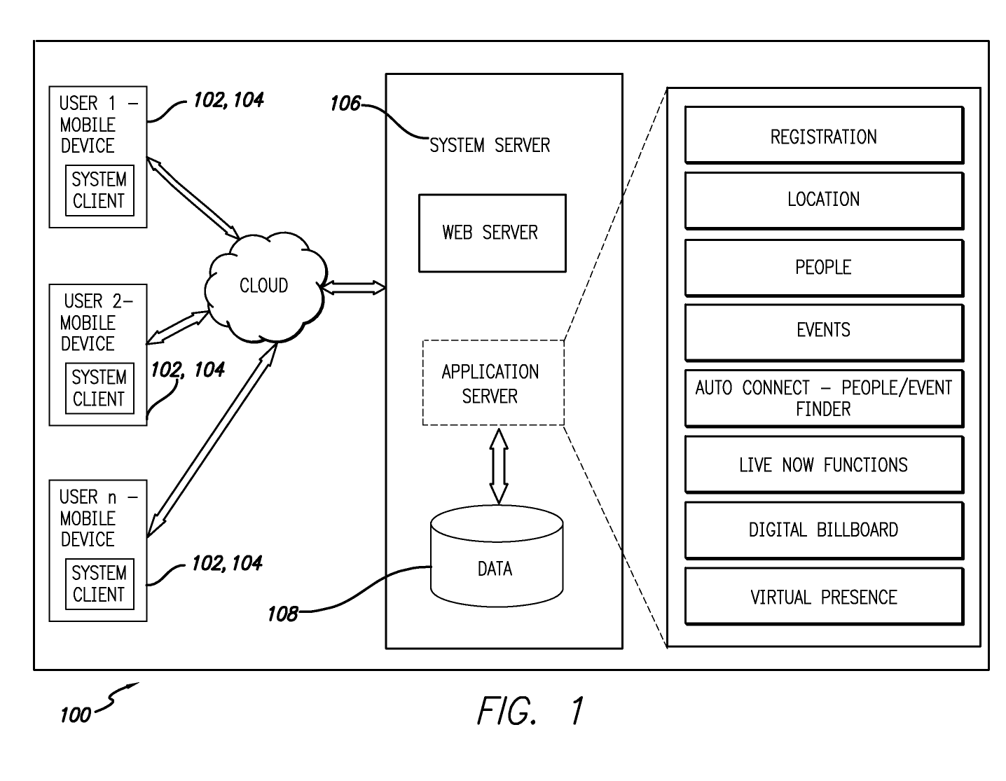

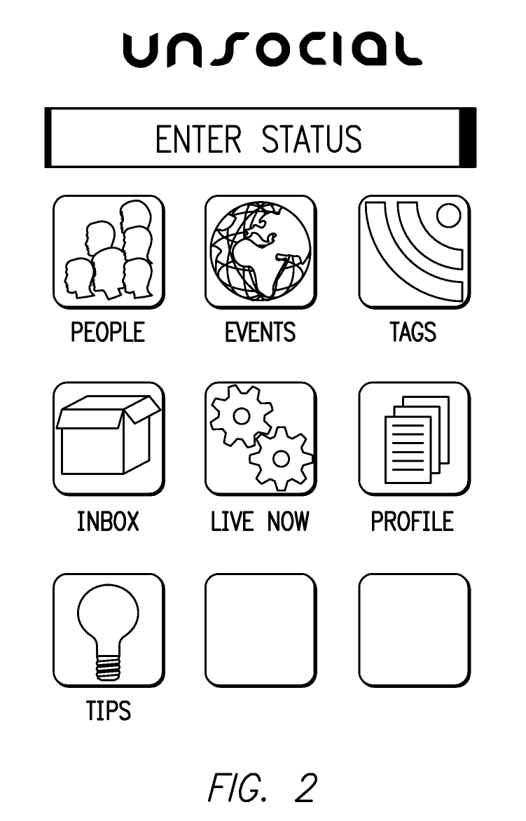

FIG. 1 illustrates the general architecture of the disclosed system. The system includes mobile devices or other computing devices, a web server that runs an application server software, and an associated database. The application server has multiple software components to feed appropriate information to end users to their respective mobile devices. End users access the system using a mobile device or other computing device that is connected to the internet. For example a user may use the system using a mobile device such as a smart phone by accessing a native client-side application of this system. Alternatively, the user can use a mobile device's internet browser to access the web-based client of this system. These mobile devices (or other computing devices that an end user may use) may be equipped with technology that enables the device to discover its geographic location, or its geo-location. Using this system, the user can always aware of other people around the user.

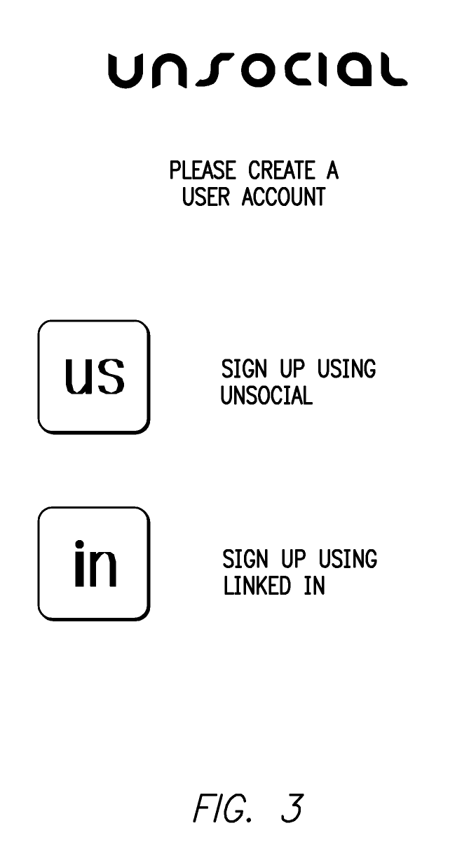

When an end user accesses this system for the first time, the system may need to know some details about this user. To interact with this system the user typically accesses a client application available on the user's mobile device, e.g., a native application of this system that is downloaded to user's smart phone. This sign up process may include: (a) the user downloads the client application of the system to user's mobile device; (b) the user executes the client application; (c) the client application recognizes that this is the first time the user is executing this application; (d) the client application displays a form to sign up with the system (in a version of the system, the client application may also provide an option to sign up with the system using another system such as LinkedIn or Facebook); an example of the display is shown in FIG. 3; (e) the user signs up using a sign up form by entering, for example, a display name, email address, and an industry; (f) the client application sends the sign up information to application server; the client application may also store this information locally on the mobile device under application private settings so that the user would not have to sign up again; and (g) the application server makes a note of this user in the database by inserting a record in its table that hosts user data.

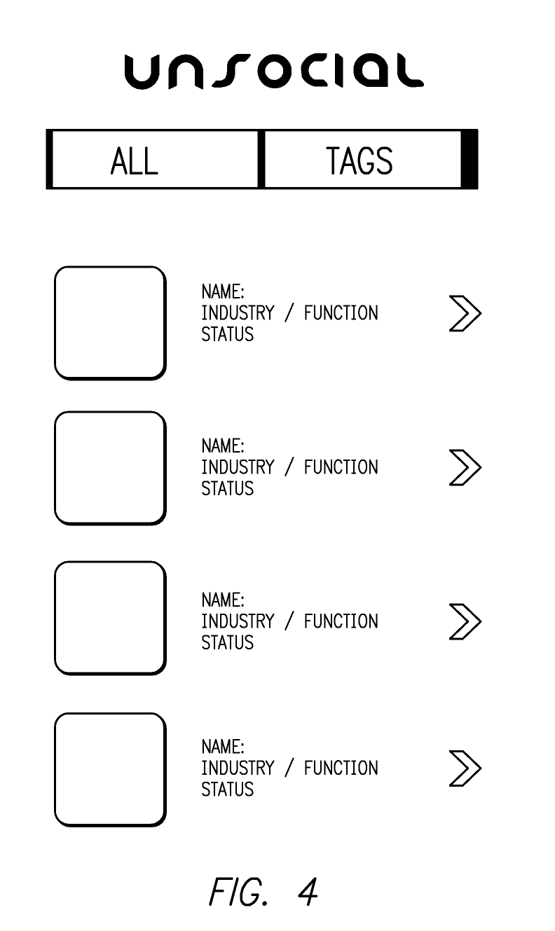

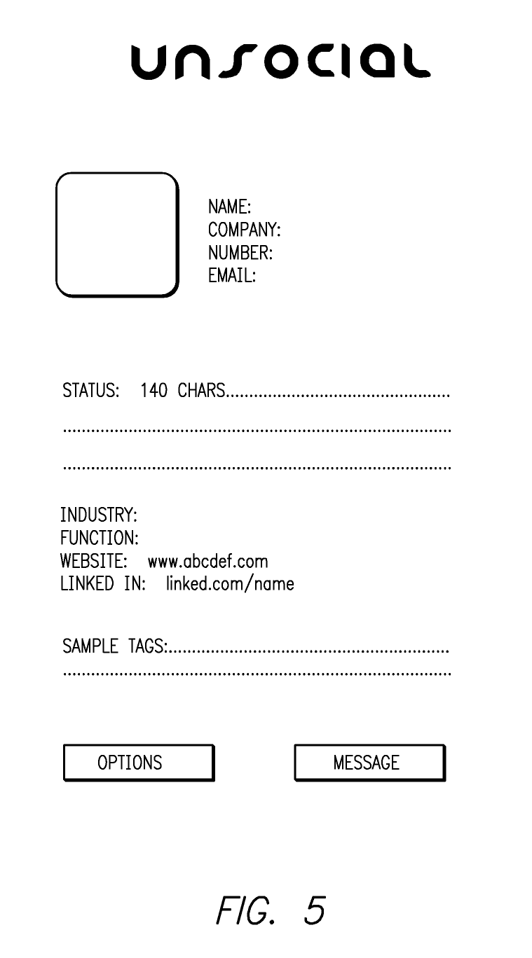

To find other people around the user, the end user may access a client application available on the user's mobile device; This feature may implement the following: (a) the user starts the client application on the mobile device; (b) the client application captures the geo-location of the mobile device (e.g., by calling an internal API provided by the device operating system); (c) the application sends a message to the application server reporting its availability in that specific location; (d) the application server inserts a record in the database regarding this users availability in that specific location; this also triggers other database table insertions to optimize searches; (e) the application server queries the database to identify other users that are in the same vicinity; (f) the application server returns results to the client application running on the mobile device; (g) the client application displays the results; an example of the display is shown in FIG. 4; (h) the user clicks on a item in the results page to see details on that person; an example of the display is shown in FIG. 5.

FIG. 12 provides additional information about finding people around the user. At “1,” the client application gets the geotag (the geo-location information) from the mobile device and sends it to the server application over internet. At “2,” the server application receives the geotag and makes an entry in the database about existence of a new user in the system. At “3.” the database adds the record in the people table, and a stored procedure is executed that indexes this user's geo-location for easy retrieval in future proximity based calls. At “4,” the server application calls the database requesting all the users that are in close proximity. At “5,” the database returns all the records to server application. If there are not enough records found a stored procedure widens the area of search automatically and returns more records until the predefined threshold (e.g. 50 records) is reached. At “6,” the server formulates the XML file and sends to the client application over internet. At “7,” the client application displays the results as a list of users in proximity. At “8,” the user may click on “More” button after reaching to the end of the list. In this case the server makes a further call to database to return next set of records.

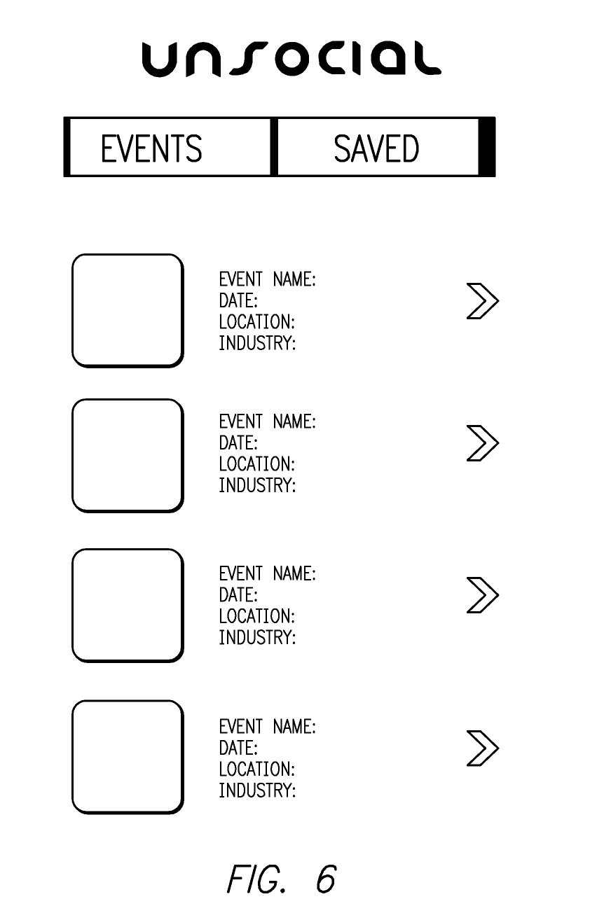

To find events around the user, the end user may access a client application available on the user's mobile device. The details of this feature can be similar to the people section described previously. An example of the display is shown in FIG. 6. The user may have a choice of seeing details of any specific event. When on event detail page, the user can see other users who are “intending to attend” this event. Also, the user can easily click on a button and that makes that user part of the list of “intend to attend” users of this event.

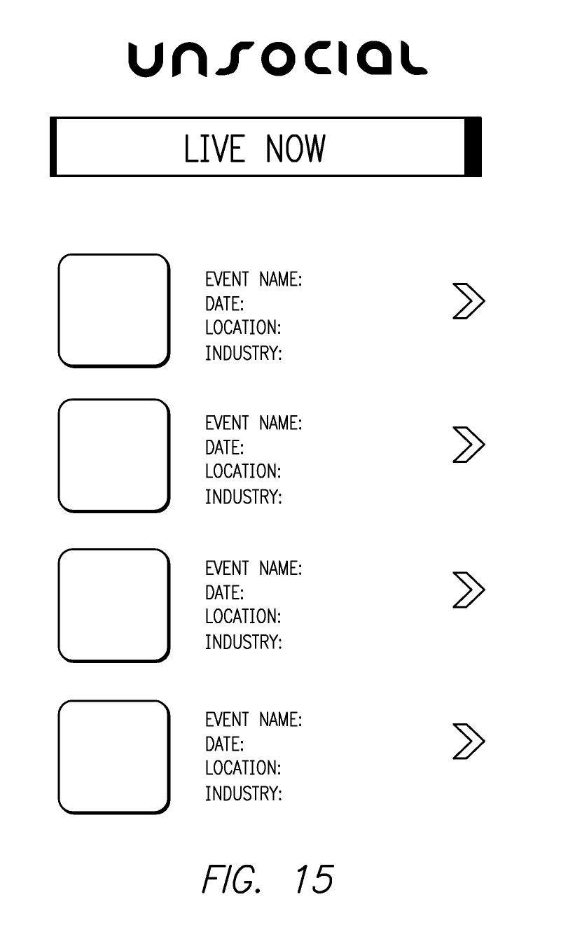

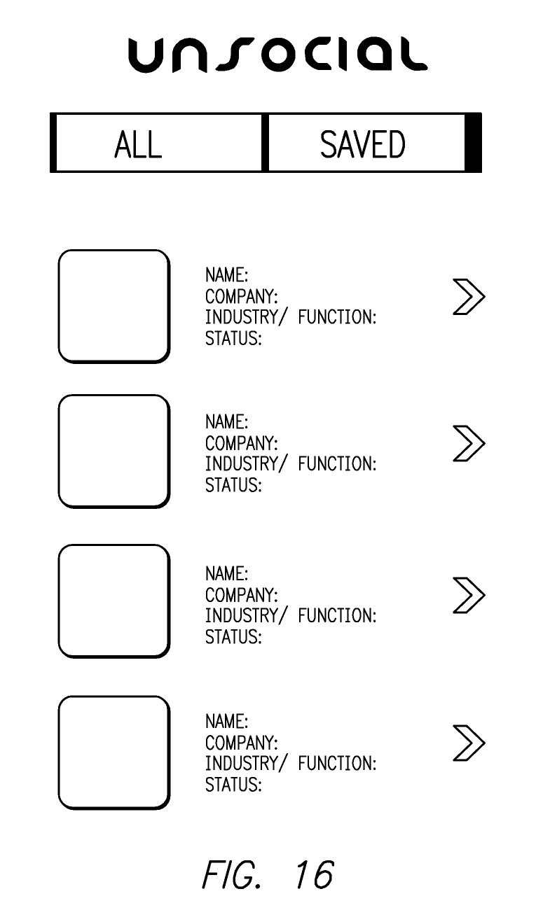

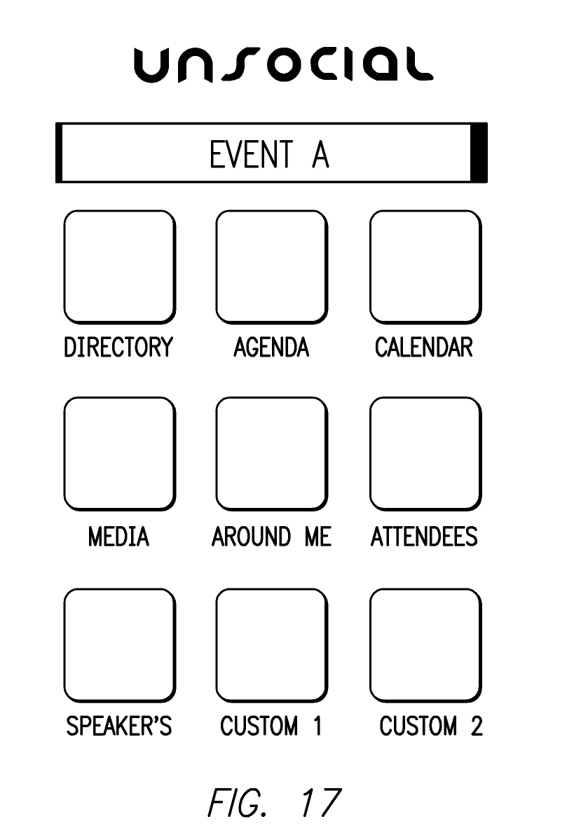

FIG. 14 provides additional information about finding events around the user. At “1,” the client application gets the geo-tag from the device and sends it to the server application over internet. At “2,” the server application calls the database requesting all the events that are in close proximity. At “3.” the database returns all the records to server application. If there are not enough records found a stored procedure widens the area of search automatically and returns more records until the predefined threshold (e.g., 50 records) is reached. At “4,” the server formulates the XML, file and sends to the client application over internet. At “5,” the client application displays the results as a list of events in the proximity. At “6,” the user may click on the “More” button after reaching the end of the list. In this case the server makes a further call to database to return next set of records.

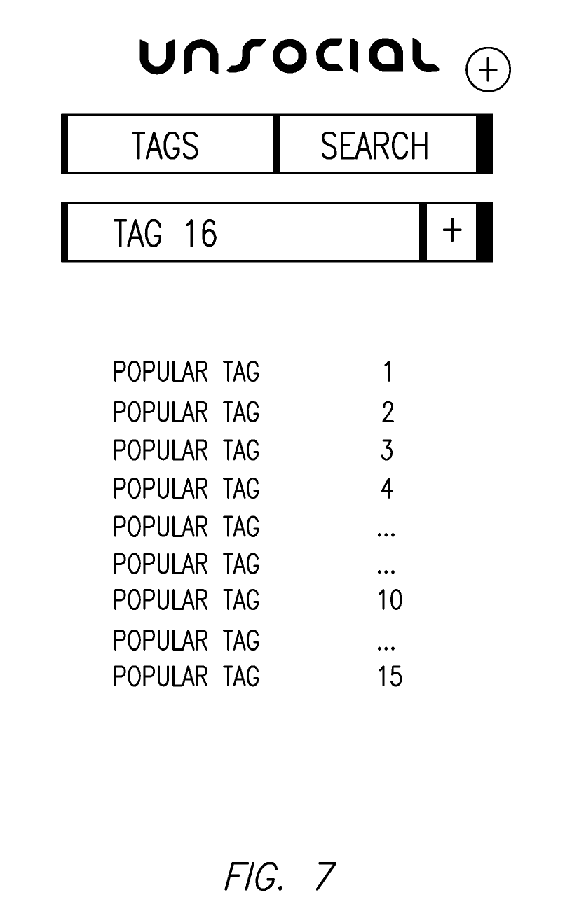

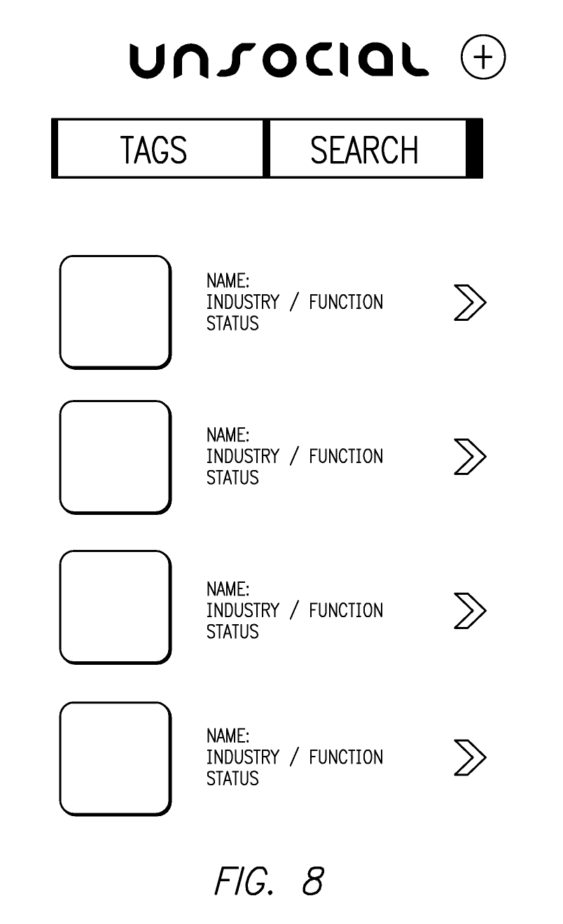

The system may provide an automatic way of identifying individuals that tit into a user's interest. Examples of the displays are shown in FIG. 7 and FIG. 8. The following describes how the feature may be implemented: (a) the user enters keywords of his/her interest; (b) the client application sends a message to the application server with these keywords as the user's interest; (c) the application server enters these keywords in its database; (d) the application server runs a query in the database to search which user's profile has these keywords; (e) the application server sends the results to the user; and (f) the client application displays the results.

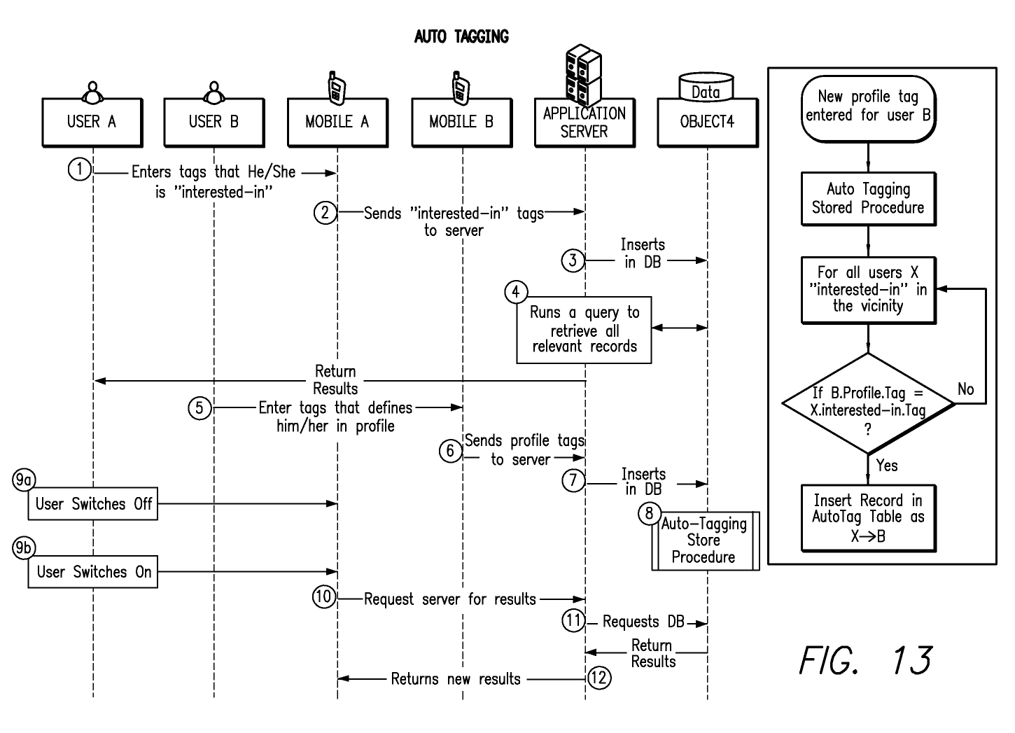

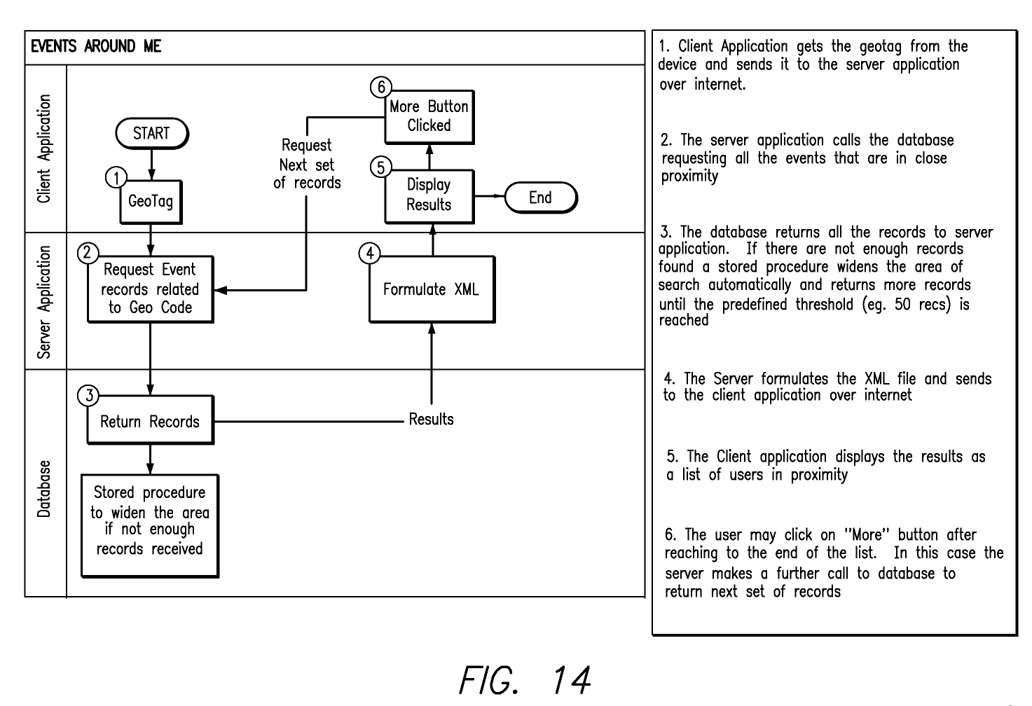

FIG. 13 provides additional information about the keyword tagging and auto tagging features. At “1,” User A enters interested-in: tag(s) on his mobile phone A using client application. At “2,” the client application sends these tag(s) to the application server. At “3.” the application serer makes entries in DB (the database) for these “interested-in” tag(s) At “4,” the application server runs a query against the database to retrieve all the profiles (in the vicinity) that has these tag(s) set in their profile. These results are returned to user A for instantaneous viewing. At “5,” user B enters profile tag(s) on his/her mobile phone B using client application. At “6,” the client application sends these tag(s) to the application server. At “7,” the application server inserts these tag(s) to the database. At “8,” the database has a stored procedure that creates additional records on “auto-tag” table. In this case if user B's profile tag matches with user A's interested-in tag, the auto-tag table will have an additional record. Also note if user 13 does not enter a profile tag but just opens the app, then the auto-tag table will also have an additional record. This record is only entered for those users who were in the vicinity (for example, a given radius range such as ten miles) and given timeout period (for example, the past four hours). At “9,” user A switches off the mobile phone and switches on the mobile after several hours (could be more than At “4,” hours, for example). At “10,” the client application requests new results from the server. At “11,” the server queries the DB for new results. The DB return new results from auto tag table to server. At “12,” the server returns the results.

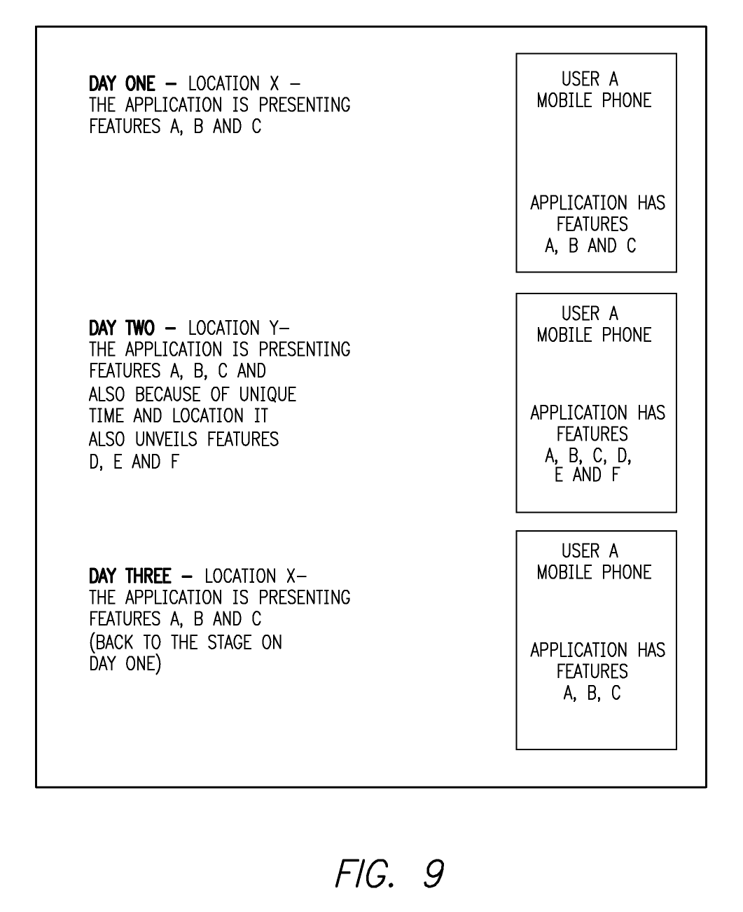

The system may provide a mechanism to unhide specific features in a context of time and space. The “Live now events” is an example of this. FIG. 9 illustrates a conceptual flow of features offered by the application in a three day span while the user is changing locations. An event organizer, or sponsor, registers an event using a web console of this application. The system later identifies that this event is “live now” based on its time, and provides this event's specific features to the user if they are in the vicinity (nearby location). The following explains this “live now” feature.

The event sponsor registers the event using a web console. The web console provides a form asking details of the event, such as the event name, time during the event should be considered live now, the event address, etc. The console also asks which specific features this event should display when the event is live. For example the sponsor may have a choice of picking as many features as they want from the check box based menu. The system supports a set of features that is related to an event, such as the event agenda, event exhibitors, speaker profiles, event videos, event photos, event live video, etc. The sponsor selects some or all of these features. Preferably, it is the sponsor's responsibility to provide content relating to these features using the web console. Next, the client application starts and sends its location to the server. Then, the server recognizes based on time and location of the user that there is a “live” event in the proximity. The server program returns the event information to client, and the client program receives the data about the live program. Then, the client program's live now section unhides features based on the sponsor's selection on the web console. The user now can access these individual items in the client application.

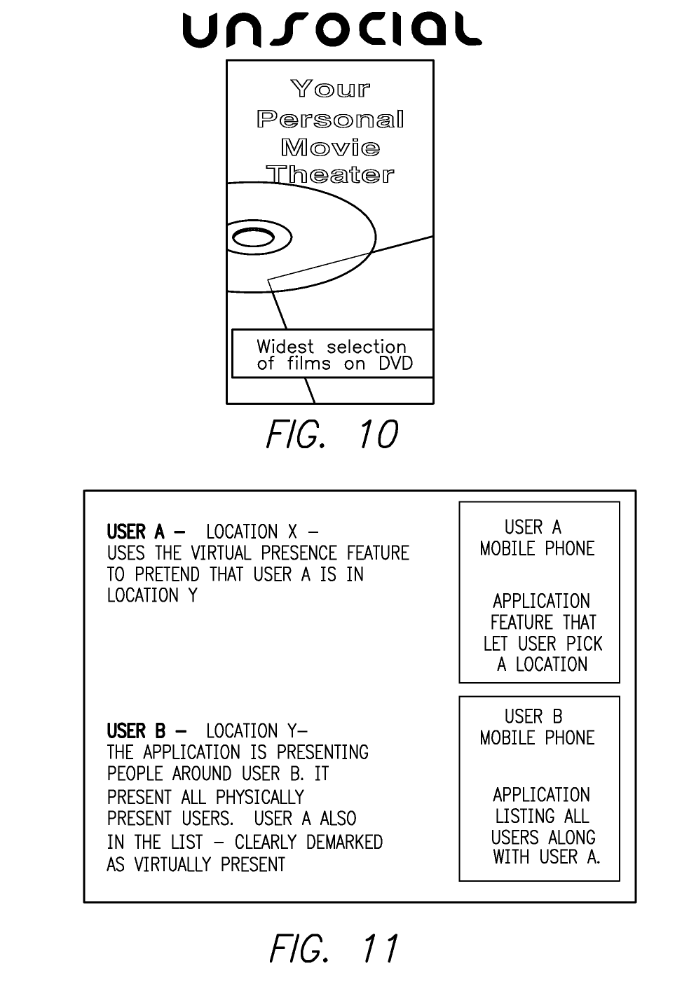

The system can enable a user display their “digital billboard” on specific areas of the application client interface. A “digital billboard” may appear when a user's profile is accessed, but it may also be displayed if a user's interest is matched. The user may set up the digital billboard by accessing this feature on client interface. The client interlace provides a wizard to create this billboard for the user, or it can enable the user provide a pre-created billboard. The application then sends the digital billboard to the server. When another user accesses the user's profile on the client, this digital billboard is presented to the other user. An example of a digital billboard is shown in FIG. 10.

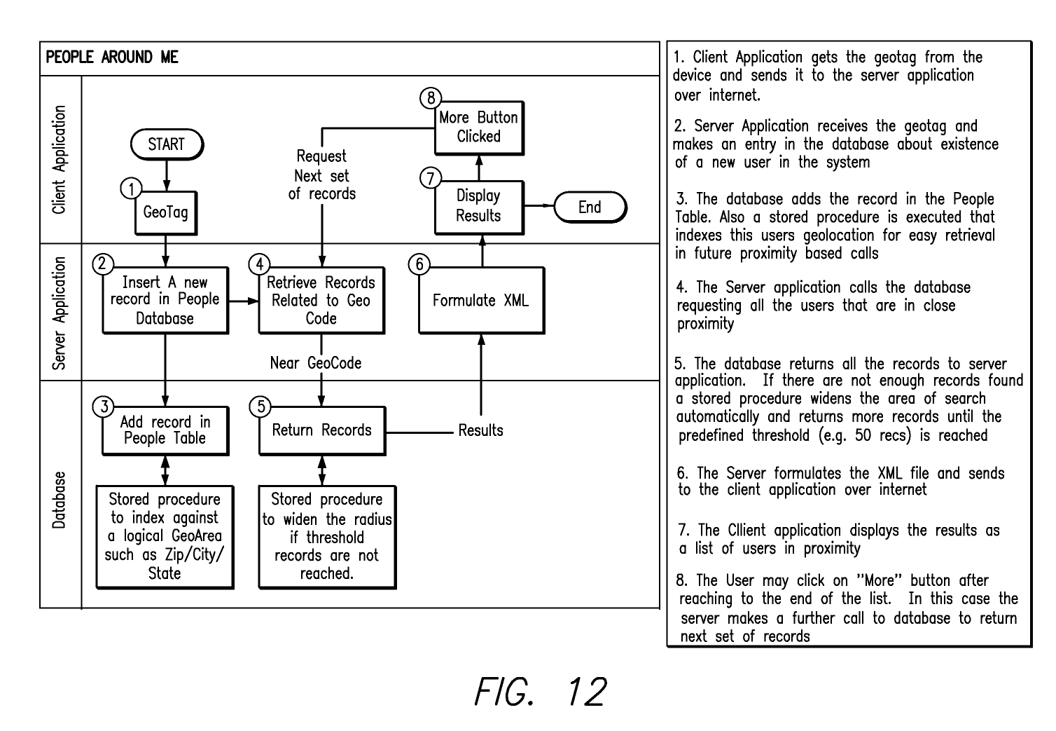

The system can enable a user to “broadcast” his or her presence at a geo-location without requiring them to be physically present there. This feature is called a “Virtual presence,” and it may be a premium service that the user may purchase a subscription (or with one time fees) for to be able to use this feature. The user's presence can be identified in a list of users as a “virtually present” individual so that they are distinguished from the individuals that are physically present. FIG. 11 shows the conceptual flow for this feature. For example: (a) the user subscribes for this service (using a web console or using the client application); this makes the feature available on user's client application; (b) the user changes the location using the virtual presence feature; the user can select up to any number of locations based on subscription amount; (c) the client sends a message to the server with all location user wants to be virtually present; (d) the server makes respective entries in the database for these virtually present users; (e) the next time any other user is in the vicinity the client receives this virtually present user along with other records from the server. Based on the flag for virtual presence the client displays this user differently identifying that this user is virtually present.

Accordingly, and with reference to the figures, one aspect of the invention can be described as a proximity-based awareness system 100 for a group of users 102. The group of users 102 includes an illustrative user and other users. In this context, the “illustrative” user is an example of a user that is utilized to illustrate or explain the system. “Other users” refers to those in the group of users other than the illustrative user. The system 100 is not dependent on the identity of the particular user. Rather, anyone of the group of users can be viewed as being the illustrative user in the description that follows.

The awareness system 100 includes a mobile computing device 104 for each user in the group of users 102 and a system server 106. The mobile computing device 104 could be a laptop computer, mobile telephone, tablet computer, or other such portable device that can remotely access a server.

The system server 106 is remote from, but in communication with, each of the mobile computing devices 104, and the system server 106 includes a database 108. During operation, the system server 106 may perform all or some of the following steps: (a) enabling the illustrative user to create and edit a personal profile of the illustrative user containing information about the illustrative user; (b) enabling the illustrative user to select a privacy setting to limit a shareable level of information about the illustrative user in the illustrative user's personal profile; (c) broadcasting the illustrative user's personal profile to at least one of the other users based on the privacy setting, each of the other users having a respective other user's personal profile; (d) enabling the illustrative user to search for and view at least one other user's personal profile; (e) enabling the illustrative user to search for and view an event profile, the event profile being associated with an event occurring within a proximity boundary, the proximity boundary being a predetermined distance from the mobile computing device of the illustrative user; (f) enabling the illustrative user to disclose to the other users an intention to attend the event, the intention to attend the event being visible to the other users upon viewing the event profile; (g) automatically bookmarking an interesting event based on one or more keywords previously provided by the user; (h) automatically identifying an interesting other user based on the one or more keywords; (i) storing a profile image associated with the illustrative user; (j) storing a profile video associated with the illustrative user; and (k) recording the identifying information for the first geographic location in the database.

Each mobile computing device includes a processor. During operation, the processor may perform all or some of the following steps: (a) determining a first geographic location of the illustrative user, such as by executing an application programming interface (API) to access a geo-locating application; (b) transmitting identifying information for the first geographic location to the system server 106; (c) providing an interface to enable the illustrative user to interact with the system server 106, transmit information to the system server 106, and display information received from the system server 106; (d) displaying at least one other user's personal profile; (e) displaying the profile image; (f) displaying the profile video: (g) displaying the event profile; (h) displaying a list of users present and virtually present within the proximity boundary, the list including an indicator showing which of the group of users is present and which of the group of users is virtually present; and (i) allowing the user to enter the one or more keywords.

In addition, the system server 106 may also perform one or both of the following steps: (a) automatically registering the illustrative user based on the first geographic location of the illustrative user, and (b) designating a virtual presence at a second geographic location that is distinct from the first geographic location.

While the present invention has been described with regards to particular embodiments, it is recognized that additional variations of the present invention may be devised without departing from the inventive concept.

### INDUSTRIAL APPLICABILITY

This invention may be industrially applied to the development, manufacture, and use of mobile devices having computing applications to facilitate social and business networking.

What is claimed is:

1. A proximity-based awareness system for a group of users, the group of users including an illustrative user and other users, the system comprising a mobile computing device for each user in the group of users and a system server, where:
(a) the system server is remote from but in communication with each mobile computing device, the system server includes a database, and the system server performs the steps of:
(i) enabling the illustrative user to create and edit a personal profile of the illustrative user containing information about the illustrative user,
(ii) enabling the illustrative user to select a privacy setting to limit a shareable level of information about the illustrative user in the illustrative user's personal profile,
(iii) broadcasting the illustrative user's personal profile to at least one of the other users based on the privacy setting, each of the other users having a respective other user's personal profile,
(iv) enabling the illustrative user to search for and view at least one other user's personal profile,
(v) enabling the illustrative user to search for and view an event profile, the event profile being associated with an event occurring within a proximity boundary, the proximity boundary being a predetermined distance from the mobile computing device of the illustrative user,
(vi) enabling the illustrative user to disclose to the other users an intention to attend the event, the intention to attend the event being visible to the other users upon viewing the event profile,
(vii) automatically bookmarking an interesting event based on one or more keywords previously provided by the user,
(viii) automatically identifying an interesting other user based on the one or more keywords,
(ix) storing a profile image associated with the illustrative user,
(x) storing a profile video associated with the illustrative user, and
(xi) recording the identifying information for the first geographic location in the database;
(b) each mobile computing device has a processor, and the processor performs the steps of:
(i) determining a first geographic location of the illustrative user by executing an application programming interface (API) to access a geo-locating application,
(ii) transmitting identifying information for the first geographic location to the system server,
(iii) providing an interface to enable the illustrative user to interact with the system server, transmit information to the system server, and display information received from the system server,
(iv) displaying at least one other user's personal profile,
(v) displaying the profile image,
(vi) displaying the profile video,
(vii) displaying the event profile,
(viii) displaying a list of users present and virtually present within the proximity boundary, the list including an indicator showing which of the group of users is present and which of the group of users is virtually present,
(ix) allowing the user to enter the one or more keywords; and
(c) the system server also performing the steps on
(i) automatically registering the illustrative user based on the first geographic location of the illustrative user, and
(ii) designating a virtual presence at a second geographic location that is distinct from the first geographic location.
